(19) United States
(12) Patent Application Publication
(10) Pub. No.: US 2026/0054385 A1
(43) Pub. Date: Feb. 26, 2026

(54) CONTROLLING A POSITION OF A HOLLOW MOULDED FIBRE PRODUCT

(71) Applicant: Pulpex Limited, Sawston (GB)

(72) Inventor: Harry Alexander BUTCHER, Sawston (GB)

(21) Appl. No.: 19/376,165

(22) Filed: Oct. 31, 2025

Related U.S. Application Data
(63) Continuation of application No. PCT/GB2024/051210, filed on May 9, 2024.

(30) Foreign Application Priority Data
May 9, 2023 (GB) 2306831.5

(51) Int. Cl. B25J 9/16; B25J 11/00; B25J 13/08; B25J 15/00

(52) U.S. Cl. CPC B25J 9/1664; B25J 9/1612; B25J 11/0075; B25J 13/085; B25J 15/0023

(57) ABSTRACT

Disclosed is a method of controlling a position of a hollow moulded fibre product to enable at least one processor to perform a process on the hollow moulded fibre product. The method comprises conforming a retainer to at least a majority of an outside perimeter of the hollow moulded fibre product; and then using the retainer to control the position of the hollow moulded fibre product relative to the at least one processor.

### CROSS-REFERENCE TO RELATED APPLICATIONS

This application is a continuation under 35 U.S.C. § 120 of International Application No. PCT/GB2024/051210, filed May 9, 2024, which claims priority to United Kingdom Application No. GB 2306831.5, filed May 9, 2023, under 35 U.S.C. § 119 (a). Each of the above-referenced patent applications is incorporated by reference in its entirety.

### TECHNICAL FIELD

The present invention relates to methods of, and devices for, controlling a position of a hollow moulded fibre product, such as a hollow moulded fibre product formed from a fibre suspension comprising paper pulp. The hollow moulded fibre product may be, or may form the basis of, a receptacle. The receptacle may be consumer packaging, such as a bottle, a jar, or a certain type of vase, useful for holding a liquid, powder, other flowable material, one or more solid objects, or a combination thereof.

### BACKGROUND

It is desirable to reduce glass and plastics use in consumable items, particularly packaging. Non-necked receptacles, such as trays, bowls and other simple shapes, are commonly made from paper pulp. However, a more complex necked receptacle, like a bottle, jar or certain types of vase, is more difficult to manufacture due to an internal narrowing of the receptacle between a main body portion of the receptacle and an opening of the receptacle.

Some types of receptacle need to be internally treated, for example coated to restrict ingress of air or moisture from outside the receptacle and restrict leakage of the receptacle's contents into the material of the receptacle's walls. Some receptacles will also need to be moved between processing stations during manufacture. A challenge lies in retaining and/or moving such a receptacle, while avoiding damage to the receptacle and permitting access to an interior surface of the receptacle for coating or other treatment, such as inspection.

### SUMMARY

According to a first aspect of the present invention there is provided a method of controlling a position of a hollow moulded fibre product to enable at least one processor to perform a process on the hollow moulded fibre product. The method comprises conforming a retainer to at least a majority of an outside perimeter of the hollow moulded fibre product; and then using the retainer to control the position of the hollow moulded fibre product relative to the at least one processor.

The retainer being conformable in this manner may enable the retainer to hold the hollow moulded fibre product more steadily than may be possible with a non-conformable retainer.

Conforming the retainer to the majority of the outside perimeter of the hollow moulded fibre product may advantageously allow the position of the hollow moulded fibre product to be controlled while allowing access to an interior of the hollow moulded fibre product. This allows processes, such as interior coating or interior inspection, of the hollow moulded fibre product to be undertaken. Further, once applied, any interior coating may be protected from potential damage during handling, because of the conformation of the retainer being on an outside, as opposed to an inside (which is the case when, for example, an inflatable internal bladder is used to handle a hollow moulded fibre product), of the hollow moulded fibre product.

Conformation of the retainer to the hollow moulded fibre product may allow for an improved contact between the retainer and the hollow moulded fibre product, since the retainer is adapted to fit around or against the hollow moulded fibre product.

The retainer may also provide a less potentially damaging way of controlling the position of the hollow moulded fibre product compared with alternative methods. The retainer surrounds the majority (or all) of the outside perimeter, which may distribute a gripping force around the majority (or all) of the outside perimeter. In other words, the gripping force may be distributed substantially evenly around the majority (or all) of an outside surface of the hollow moulded fibre product.

Conforming the retainer to the majority of the outside perimeter of the hollow moulded fibre product may comprise urging an inner wall (or walls) of the retainer against a corresponding section of the outside surface of the hollow moulded fibre product. The retainer may therefore grip onto the outside surface of the hollow moulded fibre product through this contact. Optionally the retainer is one singular element, for example a collar. The retainer may be an annular retainer. The retainer may be a flexible retainer. The retainer may be conformable to various differently dimensioned hollow moulded fibre products, which allows for a single retainer to be suitable for different shapes and sizes of hollow moulded fibre product.

Throughout the specification, reference is made to an outside perimeter. As used herein, the perimeter can be considered as the perimeter of a cross-section taken through the hollow moulded fibre product, the cross section being perpendicular to a longitudinal axis running a length of the hollow moulded fibre product.

The majority of the outside perimeter should be understood as more than half of the outside perimeter. In some examples, the retainer conforms to at least two thirds of the outside perimeter, at least three quarters of the outside perimeter, or all of the outside perimeter. In some examples, the retainer conforms to substantially all of the outside perimeter with the exception of a closure mechanism of the retainer (when present).

The retainer extends along at least a section of the length of the hollow moulded fibre product. That is, the retainer may conform to the majority of the outside perimeter of the hollow moulded fibre product over a part of the hollow moulded fibre product's overall length. For example, the retainer may extend along at least a fifth of the length, and aptly at least a quarter of the length, of the hollow moulded fibre product. In some examples, the retainer extends along a full length of the hollow moulded fibre product. In other examples, the retainer extends along only a section of the length of the hollow moulded fibre product.

In some examples, the method is a method of controlling the position of a necked hollow moulded fibre product, such as a bottle or jar. In these examples, the method may comprise conforming the retainer to at least the majority of the outside perimeter of a main body portion of the necked hollow moulded fibre product, as opposed to, for example, a narrower neck portion or a shoulder portion bridging or joining the main body portion and the neck portion.

In some examples, the method comprises conforming plural retainers (such as spaced-apart retainers) to the outside perimeter of the hollow moulded fibre product, and then using the plural retainers to control the position of the hollow moulded fibre product relative to the at least one processor. This may enable the hollow moulded fibre product to be held more securely and/or stably than if only one retainer were to be used, particularly if the plural retainers are offset from each other along a longitudinal axis of the hollow moulded fibre product. The plural retainers may be of different respective dimensions, so that the plural retainers are better able to conform to respective differently dimensioned portions of the hollow moulded fibre product. For example, when the hollow moulded fibre product is a necked hollow moulded fibre product, one of the plural retainers may be dimensioned to conform to a relatively narrow neck portion of the hollow moulded fibre product and another of the plural retainers may be dimensioned to conform to a main body portion or a base portion of the hollow moulded fibre product, each of which would be relatively wide as compared with the neck portion. Alternatively, in some examples, one of the plural retainers may be dimensioned to conform to a shoulder portion of the necked hollow moulded fibre product, wherein the shoulder portion bridges or joins the main body portion and the neck portion.

In some examples, the at least one processor is a human. In other examples, the at least one processor is at least one non-human processor, such as at least one machine, instrument or tool.

Controlling the position of the hollow moulded fibre product may, for example, comprise any combination of movements and/or maintenance of the hollow moulded fibre product in a certain position. For example, controlling the position may comprise a combination of the following: translational movement of the hollow moulded fibre product from a first position to a second position; rotation of the hollow moulded fibre product (for example, about a central longitudinal axis, when present, of the hollow moulded fibre product); and maintenance of the hollow moulded fibre product in a fixed position.

In some examples, using the retainer to control the position of the hollow moulded fibre product comprises manoeuvring the retainer relative to the at least one processor, such that the hollow moulded fibre product is moved from a first position to a second position relative to the at least one processor.

The first position may be different from the second position. Alternatively, the first position may be the same as the second position, such as when the movement of the hollow moulded fibre product is a rotation of 360 degrees. Manoeuvring the retainer allows the hollow moulded fibre product to be manoeuvred through the engagement between the retainer and the outside surface of the hollow moulded fibre product. Using the retainer for manoeuvring the hollow moulded fibre product allows an interior of the product to remain accessible while the product is manoeuvred. Manoeuvring may comprise a rotational movement (such as a tilting movement) of the hollow moulded fibre product, a translational movement of the hollow moulded fibre product from one location to another, or a combination thereof. Manoeuvring may comprise a series of small movements, such as a turn of 90° and then a further turn of 90°, separated by a pause in rotation. The manoeuvring may comprise a rotation of the hollow moulded fibre product over at least 360 degrees, such as for inspection of the hollow moulded fibre product by the processor or for applying something to the hollow moulded fibre product by the processor, such as a barcode on the exterior of the hollow moulded fibre product or a coating on the interior of the hollow moulded fibre product. Such rotation may be about a longitudinal axis of the hollow moulded fibre product. The manoeuvring may comprise tilting the hollow moulded fibre product about an axis that is non-parallel and non-coincident with a central (e.g., longitudinal) axis of the hollow moulded fibre product, to reorientate the hollow moulded fibre product for processing by the at least one processor.

In some examples the method comprises inserting the hollow moulded fibre product at least partly through a space defined by the retainer. In some examples, the conforming is performed after the inserting, such as only after the inserting. In some examples, the conforming is performed during the inserting, such as only during the inserting. In some examples, the conforming is performed partly during the inserting and partly after the inserting.

Inserting the hollow moulded fibre product may comprise moving the hollow moulded fibre product into the space while the retainer is held stationary, or moving the retainer over the hollow moulded fibre product while the hollow moulded fibre product is held stationary (or a combination of the two, where both the hollow moulded fibre product and retainer are moved and brought together). At least a part of the hollow moulded fibre product may extend through the space such that the retainer can conform to the majority of the outside perimeter.

Inserting the hollow moulded fibre product may advantageously work in tandem with other methods of transporting hollow moulded fibre products. For example, the hollow moulded fibre product may be formed using a bladder and mould, where the bladder inflates within the mould and pushes a fibre suspension against the mould to form the hollow moulded fibre product. The bladder may subsequently be used to at least partly insert the hollow moulded fibre product into the retainer.

Optionally, inserting the hollow moulded fibre product may be automated, for example using one or more sensors to determine a position of the hollow moulded fibre product, such as when the hollow moulded fibre product is fully inserted into the retainer. A device that inserts the hollow moulded fibre product may then be controlled on the basis of an output of the sensor(s).

In some examples, the method comprises lifting the hollow moulded fibre product using the retainer, such that the retainer supports the hollow moulded fibre product. Lifting the hollow moulded fibre product may allow for access to a base of the hollow moulded fibre product, which is not possible, for example, on traditional conveyer belt systems (where a base of the hollow moulded fibre product sits on the conveyer belt). In some examples, the retainer lifting the hollow moulded fibre product may negate the need for a conveyer belt, which may save space on a production line.

In some examples, the retainer may be a sole mechanism supporting the hollow moulded fibre product while the at least one processor performs the process on the hollow moulded fibre product. This may allow for an improved manoeuvrability of the hollow moulded fibre product and/or an improved access to the hollow moulded fibre product by the at least one processor. For example, the retainer may be coupled to the at least one processor by a flexible or universal joint, such that the hollow moulded fibre product can be orientated in any direction relative to the at least one processor.

Optionally, the retainer comprises an inflatable collar for encircling the hollow moulded fibre product. A majority of an inner circumference of the collar may contact the outside periphery of the hollow moulded fibre product.

In some examples conforming the retainer comprises inflating the retainer with a fluid. The fluid may be a liquid or a gas. Optionally, the fluid is air.

The fluid may cause the retainer to conform with a snug fit around the hollow moulded fibre product. Further, inflating the retainer allows for improved conformation around the hollow moulded fibre product compared with other conformation methods that would involve conformity of a mechanical linkage to the hollow moulded fibre product, and thereby an improved gripping force between the retainer and the hollow moulded fibre product.

The inflating the retainer may comprise controlling, using a controller, a flow of the fluid from a fluid source to the retainer. The fluid source may, for example, comprise a pressurised air main, or may comprise a reservoir, storing air, and a pump that is operable to pump the air from the reservoir to the retainer. The retainer may comprise one or more sensors, such as one or more pressure sensors. The one or more sensors may transmit pressure data to the controller. The controller may control inflation of the retainer based on the pressure data. For example, the controller may stop the flow of the fluid when the fluid reaches a predetermined pressure in the retainer.

In some examples, the inflation of the retainer may take place over a predetermined time period with a known flow rate of the fluid. That is, a time period for a test retainer to be inflated to a preferred pressure for use may be calculated (or measured, using a sensor in the test retainer) prior to performance of the claimed method. The controller may then be set to control the flow of the fluid (at the known flow rate) into the retainer for that calculated time period during performance of the method. Alternatively, in some examples, inflation of the retainer may be achieved by emptying the fluid contents of a full container (such as a syringe) of known volume into the retainer, where the volume of the fluid contents of the container is equal to that required to correctly inflate the retainer. In each of these examples, the retainer may not need a sensor to feed pressure data to the controller during performance of the method, which may reduce processing requirements. Further, in examples in which plural retainers are used at once for controlling the respective positions of respective different hollow moulded fibre products, negating the need for sensors may be a cost-saving measure.

In some examples, the method comprises controlling the expansion of the retainer using a pressure sensor and a controller, such as the pressure sensor within the retainer and the controller discussed above. The pressure sensor is configured to sense a pressure in the retainer and output data representing the pressure to the controller, and the controller is configured to control the expansion of the retainer based on the data.

The controller may prevent the retainer overexerting the gripping force on the hollow moulded fibre product, and as such help to avoid damaging the hollow moulded fibre product.

In some examples, the method comprises the at least one processor processing at least part of an interior surface of the hollow moulded fibre product.

In some examples, the processing comprises coating at least part of the interior surface of the hollow moulded fibre product. The resultant internal coating may restrict ingress of air or moisture from outside of the hollow moulded fibre product, and restrict leakage into the hollow moulded fibre product's walls of contents contained therein in final use.

In some examples, the processing comprises inspecting at least part of the interior surface of the hollow moulded fibre product. This may be to allow properties of the interior surface to be determined. For example, such properties may relate to a distribution of fibres at the interior surface or a distribution of a coating on one or more walls of the hollow moulded fibre product. In some examples, the processing comprises coating the interior surface of the hollow moulded fibre product and then inspecting the coating.

In some examples, the method comprises rotating the hollow moulded fibre product, using the retainer, while the at least one processor processes the at least part of the interior surface of the hollow moulded fibre product.

In some cases, rotating the hollow moulded fibre product, using the retainer, makes the processing easier. The hollow moulded fibre product can be orientated in various directions using the retainer, for example such that a coating can be applied to most or all of the interior of the hollow moulded fibre product or such that most or all of the interior can be inspected.

In some examples, the rotating the hollow moulded fibre product, using the retainer, during the processing (such as coating) comprises rotating the hollow moulded fibre product about a rotation axis that is coincident with a longitudinal axis of the hollow moulded fibre product. In some such examples where the at least one processor comprises an interior coating device having a spray lance, the rotation axis is parallel to an axis of the spray lance. In other examples, the rotation axis is coincident with the axis of the spray lance. In still further examples, the rotation axis is instead inclined relative to the axis of the spray lance. The relationship between the location of the rotation axis and the at least one processor may be selected based on the process that the at least one processor is to perform on the hollow moulded fibre product.

In some examples, the method comprises manoeuvring the hollow moulded fibre product using the retainer after the at least one processor completes the processing of the at least part of the interior surface of the hollow moulded fibre product.

For example, the at least one processor may comprise a coating station and the method may comprise holding or manoeuvring the hollow moulded fibre product relative to the coating station, rotating the hollow moulded fibre product during the coating, and manoeuvring the hollow moulded fibre product away from the coating station. The method may comprise rotating the hollow moulded fibre product as it is moved translationally as well, for example to aid spreading and/or drying a coating uniformly.

The retainer may be capable of performing a variety of movements (which may be the same or different) that allow more than one process to be carried out on, or to, the hollow moulded fibre product, either simultaneously or one after another. This may speed up production time, as the hollow moulded fibre product does not need to be transferred between multiple manipulation mechanisms.

Optionally, the method comprises coating at least part of an exterior of the hollow moulded fibre product before conforming the retainer to the hollow moulded fibre product. This may comprise coating the outside surface to which the retainer then conforms. The coating may be an anti-scuff coating, for example, which may provide a layer of protection between the retainer and the hollow moulded fibre product to prevent scuffing of the at least part of the exterior of the hollow moulded fibre product.

According to a second aspect of the present invention there is provided a hollow-moulded-fibre-product-positioning device for controlling a position of a hollow moulded fibre product to enable at least one processor to perform a process on the hollow moulded fibre product, the hollow moulded fibre product positioning device comprising a retainer configured to be conformable to at least a majority of an outside perimeter of the hollow moulded fibre product to enable the retainer to then control the position of the hollow moulded fibre product relative to the at least one processor.

In some examples, the retainer comprises a collar configured to at least partially enclose the hollow moulded fibre product.

The collar may provide an easy conformation to the hollow moulded fibre product along with being easy to manufacture.

The collar may wrap around the hollow moulded fibre product. For example, the collar may be a strip that is manipulable to encircle the outside perimeter. The collar may comprise a closing mechanism, such as a hook and loop arrangement. In some cases, the action of wrapping the collar around the product may provide some of the conformation of the retainer described above.

The collar may have an annular cross-section, with an interior wall configured to contact the hollow moulded fibre product.

The collar may be elastic. In some examples, the collar comprises an interior cavity configured to be filled with a fluid and expand in order to conform the retainer to the outside perimeter of the hollow moulded fibre product.

In some examples, the hollow-moulded-fibre-product-positioning device comprises the at least one processor. Having the at least one processor as a component of the hollow-moulded-fibre-product-positioning device may make the processing easier, in the sense that one system of a receptacle manufacturing line may be capable of both processing and manoeuvring the product.

In some examples, the at least one processor comprises an interior processing device configured to process at least part of an interior of the hollow moulded fibre product while the position of the hollow moulded fibre product relative to the at least one processor is controlled by the hollow-moulded-fibre-product-positioning device. In some examples, the at least one processor comprises an exterior processing device configured to process at least part of an exterior of the hollow moulded fibre product while the position of the hollow moulded fibre product relative to the at least one processor is controlled by the hollow-moulded-fibre-product-positioning device.

Such an interior processing device or exterior processing device may be rotatable relative to the retainer, such that in some examples the retainer may control the position of the hollow moulded fibre product by maintaining the hollow moulded fibre product in position while the processing device rotates within the hollow moulded fibre product. The hollow-moulded-fibre-product-positioning device may comprise a controller that is configured to control the relative position of the retainer and the interior processing device.

In some examples, the interior processing device comprises an interior coating device configured to coat at least part of the interior of the hollow moulded fibre product. In some examples, the interior processing device comprises an interior inspection device configured to inspect at least part of the interior of the hollow moulded fibre product. In some examples, the interior processing device comprises both such an interior coating device and such an interior inspection device.

In some examples, the hollow-moulded-fibre-product-positioning device comprises a fluid source coupled to the retainer, the fluid source configured to inflate the retainer to cause the retainer to conform to at least the majority of the outside perimeter of the hollow moulded fibre product, in use.

The hollow-moulded-fibre-product-positioning device having the fluid source may allow for conformation of the retainer to the hollow moulded fibre product to be easily performed. This may mean the hollow-moulded-fibre-product-positioning device is transportable, such that the hollow-moulded-fibre-product-positioning device can be brought to the hollow moulded fibre product for conforming thereto.

In some examples, the hollow-moulded-fibre-product-positioning device comprises a coupling arrangement between the fluid source and the retainer, the coupling arrangement comprising: a rotary pneumatic union; or a pair of co-operable interfaces between a first valve and a second valve, the first valve and the second valve configured to close fluid flow paths from the fluid source to one of the interfaces and from the other of the interfaces to the retainer, respectively, and the pair of co-operable interfaces configured to be disconnectable from each other, to permit movement of the one of the interfaces and the fluid source relative to the other of the interfaces and the retainer, and connectable to each other to fluidically connect the first valve to the second valve.

The valves and interfaces allow disconnection of the retainer from the fluid source while the retainer remains inflated, such that subsequent rotation or other movement of the retainer relative to the fluid source is possible. The retainer may then be reattached to the fluid source after the rotation. This may allow for easier rotation or other movement of the hollow moulded fibre product compared with hollow-moulded-fibre-product-positioning devices with fixed connections, for example.

In some examples, the hollow-moulded-fibre-product-positioning device comprises a plurality of retainers, each of the retainers configured to conform to the majority of an outside perimeter of a respective hollow moulded fibre product.

The plurality of retainers may allow the positions of a plurality (corresponding to the number of retainers) of hollow moulded fibre products to be controlled simultaneously. This may allow bulk movements during production to be achieved, for example.

Optionally, the retainers are inflatable using fluid from a single fluid source, such that the retainers can be conformed to multiple respective hollow moulded fibre products (optionally simultaneously). Inflation of the retainers may be controlled by a single controller or respective controllers, for example.

According to a third aspect of the present invention there is provided a receptacle manufacturing line comprising the hollow-moulded-fibre-product-positioning device of the second aspect for controlling a position of a hollow moulded fibre product to enable at least one processor to perform a process on the hollow moulded fibre product to provide a processed hollow moulded fibre product, and apparatus for performing at least one additional process on the processed hollow moulded fibre product to provide the receptacle.

The apparatus may comprise an interior coater and the at least one additional process may comprise the interior coater coating at least a portion of an interior of the product to produce an internally coated product. The apparatus may comprise a closure-part applicator and the at least one additional process may comprise the closure-part applicator applying a closure part to the product or the internally coated product to produce a closable or closed product. The apparatus may comprise an exterior coater and the at least one additional process may comprise the exterior coater coating at least a portion of an exterior of the product or the internally coated product or the closable or closed product to produce an externally coated product. The apparatus may comprise a decorator and the at least one additional process may comprise the decorator decorating the product or the internally coated product or the closable or closed product or the externally coated product to produce a decorated product. The apparatus may comprise a dryer and the at least one additional process may comprise the dryer drying the product or the internally coated product or the closable or closed product or the externally coated product or the decorated product to produce a dried product. The apparatus may comprise an evaluator and the at least one additional process may comprise the evaluator evaluating the product, the internally coated product, the closable or closed product, the externally coated product, the decorated product, or the dried product to produce an evaluated product. In some examples, the receptacle is the product, the internally coated product, the closable or closed product, the externally coated product, the decorated product, the dried product, or the evaluated product.

In some examples, the receptacle is a necked receptacle, such as a bottle, jar or a type of vase, and the receptacle manufacturing line is a necked-receptacle manufacturing line. In some examples, the receptacle is a bottle.

According to a fourth aspect of the present invention there is provided a control system configured to cause a hollow-moulded-fibre-product-positioning-device to perform the method of the first aspect.

The control system may comprise the controller described above. That is, the control system may control, using the controller, conformation of the retainer to the outside periphery of the hollow moulded fibre product.

According to a fifth aspect of the present invention there is provided a non-transitory storage medium storing machine-readable instructions that, when executed by a computer processor of a control system of a hollow-moulded-fibre-product-positioning device, causes the computer processor to cause the hollow-moulded-fibre-product-positioning device to perform the method of the first aspect.

According to a sixth aspect of the present invention there is provided a method of manufacturing a receptacle, the method comprising performing the method of the first aspect to enable the at least one processor to perform the process on the hollow moulded fibre product to provide a processed hollow moulded fibre product, and then performing at least one additional process on the hollow moulded fibre product to provide the receptacle.

The at least one additional process may comprise coating at least a portion of an interior of the product to produce an internally coated product. The at least one additional process may comprise applying a closure part to the product or the internally coated product to produce a closable or closed product. The at least one additional process may comprise coating at least a portion of an exterior of the product or the internally coated product or the closable or closed product to produce an externally coated product. The at least one additional process may comprise decorating the product or the internally coated product or the closable or closed product or the externally coated product to produce a decorated product. The at least one additional process may comprise drying the product or the internally coated product or the closable or closed product or the externally coated product or the decorated product to produce a dried product. The at least one additional process may comprise evaluating the product, the internally coated product, the closable or closed product, the externally coated product, the decorated product, or the dried product to produce an evaluated product. In some examples, the receptacle is the product, the internally coated product, the closable or closed product, the externally coated product, the decorated product, the dried product, or the evaluated product.

In some examples, the receptacle is a necked receptacle, such as a bottle, jar or a type of vase. In some examples, the receptacle is a bottle.

According to a seventh aspect of the invention there is provided a method of providing a content-containing receptacle, the method comprising providing a receptacle obtained by the method of the sixth aspect and providing the contents in the receptacle to provide the content-containing receptacle.

In some examples, the providing the contents in the receptacle comprises putting the contents into the receptacle. In contrast, in some examples, the providing the receptacle comprises providing the receptacle with the contents already present in the receptacle, thereby providing the contents in the receptacle.

The contents may be in the form of, for example, a liquid, a powder, other flowable materials, one or more solid objects, or a combination thereof. For example, the contents may be a foodstuff such as a condiment, a beverage such as an alcoholic beverage, a household care product such as a detergent or other cleaning product, a personal care product such as a hair care product or a personal cleansing product or a healthcare product or a pharmaceutical product or a cosmetics product, a fragrance product such as a perfume, a vehicle product such as motor oil, or an industrial product. Other suitable contents will be apparent to the skilled reader in view of the content of this application and their common general knowledge.

In some examples, the receptacle is a necked receptacle, such as a bottle, a jar or a type of vase. In some examples, the receptacle is a bottle.

In some examples, the method comprises closing an opening of the receptacle after the providing contents in the receptacle, and/or applying a label or indicia to the receptacle.

In some examples, the closing comprises applying a closure (such as a lid or a cap or a heat seal) to the receptacle to close the opening. In some examples, the closing comprises applying a heat seal to the receptacle and (e.g., thereafter) applying a lid or a cap to the receptacle.

In some examples, the applying the label or indicia to the receptacle occurs after the providing the contents in the receptacle (that is, the label or indicia is applied to the content-containing receptacle). In other examples, the applying the label or indicia to the receptacle occurs before or during the providing the contents in the receptacle.

In some examples, the applying occurs before the closing. In some examples, the applying occurs after the closing. In some examples, the applying occurs during the closing.

According to an eighth aspect of the invention there is provided use of a receptacle obtained by the method of the sixth aspect to contain contents.

The use could be, for example, by a person (such as a natural person or a company) who puts the contents into the receptacle, or by a person who transports the contents, or by a person who wishes to dispose of (e.g., to a consumer or end user), offer to dispose of (e.g., to a consumer or end user), import, or keep the contents whether for disposal or otherwise.

The contents may, for example, be in the form of any of those discussed above.

In some examples, the receptacle is a necked receptacle, such as a bottle, a jar or a type of vase. In some examples, the receptacle is a bottle.

It will be appreciated that optional features of aspects of the present invention may be equally applied to other aspects of the present invention, where appropriate. In particular, unless stated otherwise or fundamentally incompatible, examples of the present invention should be regarded as combinable.

### BRIEF DESCRIPTION OF DRAWINGS

Embodiments of the invention will now be described, by way of example only, with reference to the accompanying drawings, in which:

FIG. 1 is a schematic view of an example receptacle manufacturing line for performing a method of manufacturing receptacles from paper pulp;

FIG. 2 is a schematic view of an example uncapped receptacle;

FIG. 3a is a schematic plan view of an example retainer in a relaxed or uninflated configuration, and FIG. 3b illustrates the example retainer of FIG. 3a in a conformed or inflated configuration;

FIG. 4a is a schematic front view of part of an example hollow-moulded-fibre-product-positioning device including the retainer of FIG. 3a in the relaxed configuration about a hollow moulded fibre product, and FIG. 4b illustrates the part of the example hollow-moulded-fibre-product-positioning device of FIG. 4a with the retainer in the conformed configuration about the hollow moulded fibre product;

FIG. 5 is a schematic front view of the example hollow-moulded-fibre-product-positioning device of FIG. 4b, but this time showing an interior coating device, which is part of the example hollow-moulded-fibre-product-positioning device and is for coating at least part of an interior of the hollow moulded fibre product to which the retainer is conformed;

FIG. 6 is a schematic front view of the example hollow-moulded-fibre-product-positioning device of FIG. 4b, but this time showing an interior inspection device, which is part of the example hollow-moulded-fibre-product-positioning device and is for inspecting at least part of the interior of the hollow moulded fibre product to which the retainer is conformed;

FIG. 7 is a block diagram of an example method of controlling a position of a hollow moulded fibre product;

FIG. 8 shows a non-transitory computer-readable storage medium according to an example;

FIG. 9 shows a schematic cross-sectional view of a receptacle containing contents, according to an example; and

FIG. 10 shows a method of providing a content-containing receptacle.

### DETAILED DESCRIPTION

The following description presents exemplary embodiments and, together with the drawings, serves to explain principles of embodiments of the invention. Throughout the description like numerals refer to like parts.

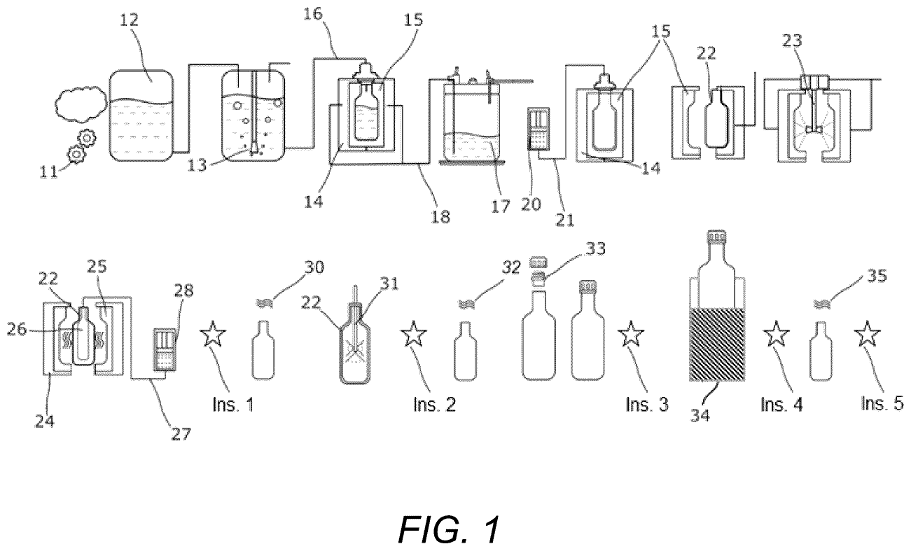

FIG. 1 shows a receptacle manufacturing line for performing a method of manufacturing receptacles, in this case necked receptacles, and more specifically in this case in the form of bottles, from paper pulp (i.e., which can form the basis of an example fibre suspension). By “necked receptacle” it is meant that the receptacle has an internal narrowing, or “neck”, between a main body portion, in which most of or all the contents of the receptacle are stored in use, and an opening through which the contents can enter or leave the receptacle in use. The internal width of the receptacle at the neck may be the same as or different to the internal width of the opening. However, the internal width of the neck is smaller than that of the main body portion, so that a shoulder is defined by and between the neck and the main body portion. This shoulder complicates manufacture of the receptacle, since it interferes with subsequent removal (and, in some cases, insertion) of whatever mould tool is inserted into the receptacle to form the internal shape of the receptacle. Examples of necked receptacles are bottles, jars, and certain types of vases. The process is merely exemplary and is provided to give context to examples of the present invention. It will be appreciated that, in other examples, the receptacle manufacturing line could be for making non-necked receptacles (i.e., receptacles without such a neck), such as bowls or trays.

Broadly speaking, the exemplary process comprises providing a fibre suspension, introducing the fibre suspension into a mould cavity of a porous first mould and expelling a liquid (such as water) from the fibre suspension to produce a hollow moulded fibre product (which may be called a wet precursor or embryo) in the mould cavity, further moulding the hollow moulded fibre product to produce a hollow further-moulded fibre product, drying and then internally-coating the hollow further-moulded fibre product to produce an internally coated product, drying the internally coated product to produce a dried product, applying a closure part to the dried product to produce a closable or closed product, externally-coating and/or decorating the closable or closed product to produce an externally coated and/or decorated product, and then drying the externally coated or decorated product to produce another dried product. As will be apparent at least from the following description, modifications may be made to the exemplary process to provide variants thereof in which other examples of the present invention may be embodied. For example, in some cases, either the internal coating or the external coating and/or decorating may be omitted. Moreover, in the present case and as indicated by the stars labelled Ins. 1 to Ins. 5 in FIG. 1, the process comprises inspecting or evaluating the hollow further-moulded fibre product, the internally coated product, the closable or closed product, the externally coated or decorated product, and the dried product to produce respective evaluated products. In some examples, the receptacle is the hollow moulded fibre product, the hollow further-moulded fibre product, the internally coated product, the closable or closed product, the externally coated or decorated product, one of the dried products, or one of the respective evaluated products.

In this example, providing the fibre suspension comprises preparing the fibre suspension from ingredients thereof. More specifically, the preparing comprises providing pulp fibres, such as paper pulp fibres, and mixing the pulp fibres with a liquid to provide hydrated pulp fibres. In this example, the pulp fibres are provided in sheet form from a supplier and the liquid comprises water and one or more additives. In this example, the liquid is mixed with the pulp fibres to provide hydrated pulp fibres having a solid fibres content of 1 wt % to 5 wt % (by dry mass of fibres). In examples, the one or more additives includes a sizing agent, such as alkylketene dimer (AKD). The hydrated pulp fibres typically comprise AKD in an amount of 0.4 wt % with respect to the total dry mass of the solid fibres in the hydrated pulp fibres. In some examples, one or more additives are present in the liquid at the point of mixing the pulp fibres with the liquid. In some examples, one or more additives are included in the hydrated pulp fibres after mixing the pulp fibres with the liquid (for example, the pulp fibres are hydrated for a period of time, such as from 2 to 16 hours, and then one or more additives are supplied to the hydrated pulp fibres). The hydrated pulp fibres are passed between plates of a valley beater 11 or refiner that are in motion relative to each other. This fibrillates some, or all, of the fibres, meaning that cell walls of those fibres are caused to become partially delaminated so that wetted surfaces of those fibres comprise protruding hairs or fibrillations. These fibrillations will help to increase a strength of bonds between the fibres in the dried end product. In other examples, the valley beater 11 or refiner may be omitted.

The resultant processed pulp is stored in a vat 12 in a relatively concentrated form (for example, a solid fibres content of 1 wt % to 5 wt %) to reduce a required storage space. At an appropriate time, the processed pulp is transferred to a mixing station 13 at which the processed pulp is diluted in further water and, optionally, mixed with one or more additives (as well as, or in place of, the one or more additives provided with the hydrated pulp fibres) to provide the fibre suspension ready for moulding. In this example, the solid fibres account for 0.7 wt % of the resultant fibre suspension (by dry weight of fibres), but in other examples the proportion of solid fibres in the fibre suspension may be different, such as another value in the range of 0.5 wt % to 5 wt %, or 0.1 wt % to 1 wt %, of the fibre suspension (by dry weight of fibres). In some examples, the one or more additives mixed with the processed pulp and water includes a dewatering agent, such as modified and/or unmodified polyethylene imine (PEI), for example modified PEI sold under the trade name Polymin® SK. In some examples, the one or more additives are mixed with the water, and the water and one or more additives subsequently mixed with the processed pulp; in other examples, the processed pulp and water are mixed, and the one or more additives subsequently mixed with the processed pulp and water. The fibre suspension typically comprises Polymin® SK in an amount of 0.3 wt % with respect to the total dry mass of the solid fibres. Mixing of the fibre suspension at the mixing station 13 helps to homogenise the fibre suspension. In other examples, the processed pulp or the fibre suspension may be provided in other ways, such as being supplied ready-made.

Downstream of the vat 12 and the mixing station 13 is a first moulding station that comprises a porous first mould 15. In this example, the porous first mould 15 comprises two half-moulds 14 that are movable towards and away from each other, in this case using a hydraulic ram. In this example, each of the half-moulds is a monolithic or unitary tool formed by additive manufacturing (for example, 3D-printing) that defines a mould profile, and, when the half-moulds are brought into contact with each other, their respective mould profiles cooperate to define the mould cavity in which the hollow moulded fibre product is to be formed. Each half-mould itself defines a smaller moulding cavity and, when brought into cooperation with a second half-mould, the smaller moulding cavities combine to provide the overall mould cavity. The two half-moulds may themselves be considered “splits” or “moulds” and the overall porous first mould 15 may be considered a “split-mould” or, again, a “mould”. In other examples, the porous first mould 15 may comprise more than two splits, such as three, four or six splits, that cooperate to define the moulding cavity.

In FIG. 1, the fibre suspension (also known as slurry) is top-filled into the porous first mould 15, in contrast to moulding processes that dip a mould in slurry. The fibre suspension is drawn under vacuum via a line 16 and into the porous first mould 15, with excess suspending liquid being drawn through the porous first mould 15 under vacuum via a line 18 into a tank 17. Shot mass may be controlled by measuring (for example, weighing) the amount of liquid drawn into the tank 17. A weight scale platform supporting the tank 17 is visible in FIG. 1. Once a required amount (for example, a predetermined volume, such as 10 litres, or a predetermined mass, such as 10 kilograms) of liquid has been collected in the tank 17, suction of the suspending liquid through the porous first mould 15 is stopped and the first mould 15 is opened to ambient air. In this example, the suspending liquid drawn with the fibre suspension in line 16 is water, or predominantly water (as additives may also be present). The liquid drawn under vacuum via the line 18 and into the tank 17 is substantially free of fibres, since these are left behind against the walls of the porous first mould 15 to form the hollow moulded fibre product.

In one example, in order to remove further suspending liquid (for example, water) from the hollow moulded fibre product, and form or consolidate the three-dimensional shape of the product, high pressure fluid (such as compressed air) is introduced into the first mould 15 to compress the fibre suspension against the cavity wall of the first mould 15. This process strengthens the product so that it can be handled, and displaces water from in between the fibres, thereby increasing the efficiency of a subsequent drying process. The fluid is regulated using a hydraulic pump 20. The pump 20 has a cylinder that displaces the fluid in a line 21 into the first mould 15. In an alternative example, an impermeable inflation element in the form of a collapsible bladder is inserted into the first mould 15 and expanded, by introduction of a fluid into the bladder from the line 21, to act as an internal high-pressure core structure for the first mould 15. In such an alternative, the fluid within the line 21 is preferably non-compressible, such as water or oil, although in other examples it could be a compressible fluid, such as air. Water has the advantage over other non-compressible liquids that any leaking or bursting of the bladder will not introduce a new substance to the system (since the suspending liquid is already water, or predominantly water).

Demoulding occurs when the first mould 15 opens for removal of the self-supporting hollow moulded fibre product 22. Mould cleaning 23 is preferably performed subsequently, to remove any remaining small fibres and/or other debris and maintain a porosity of the porous first mould 15. In this example, a radially firing high-pressure jet is inserted into the mould cavity while the first mould 15 is open. This dislodges debris from the wall of the mould cavity. Alternatively, or in addition, water from the tank 17 is pressurised through the back of the porous first mould 15 to dislodge entrapped fibres and/or other debris. Water is drained for recycling back to an upstream part of the system. It is noteworthy that cleaning is important for conditioning the first mould 15 for re-use. The first mould 15 may appear visibly clean after removal of the receptacle, but its performance could be compromised without cleaning.

According to FIG. 1, the hollow moulded fibre product 22 is subsequently transported to a second moulding station where, in an aluminium mould 25, for example, pressure and heat are applied for thermoforming a desired neck and surface finish, optionally including embossed and/or debossed surface features. After two halves of the mould 25 have closed around the product 22, a pressuriser is engaged. For example, a bladder 26 (for example, a thermoforming bladder 26) is inserted into the product 22. The bladder 26 is inflated with a pressurised fluid supplied via a line 27 by a pump 28. The pressurised fluid is preferably a non-compressible fluid such as water or oil, although in other examples it could be a compressible fluid such as air. In other examples, during supply, the pressurised fluid is heated with, for example, a heater or, alternatively, is cooled with, for example, a heat exchanger. An external mould block 24 of the mould 25, and/or the mould 25 itself, is also, or alternatively, heated in some examples. After thermoforming, a state of the product 22, which may now be considered a hollow further-moulded fibre product, is considerably more rigid, with more compressed side walls, as compared with the state of the product 22 at demoulding from the first mould 15.

A drying stage 30 (for example, a microwave drying process or other drying process) is performed on the product 22 downstream of the thermoforming, as shown, to provide a dried product. In one example, the drying stage 30 is performed before thermoforming to provide a dried product. However, moulding in the mould 25 requires some water content to assist with bonding during the compression process. The drying may be performed using a dryer, such as a machine that acts to cause drying of the product or simply a shelf or other support on which the product 22 rests while drying.

The product 22 is then subjected to an internal-coating stage during which, in this example, an interior coating device in the form of a spray lance 31 is inserted into the product 22 and applies one or more surface coatings to internal walls of the product 22 to produce an internally coated product. In another example, the product 22 is instead filled with and subsequently drained of a liquid that coats the internal walls of the product 22. In practice, such coatings provide a protective layer to prevent egress of contents into the bottle wall, which may permeate and/or weaken it. Coatings will be selected dependent on the intended contents of finished receptacle, for example, a beverage, foodstuff, detergent, lubricant, pharmaceutical product, etc. In this example, the internally coated product 22 is then subjected to a curing or drying process 32, which can be configured or optimised dependent on the internal coating, for example, drying for twenty-four hours at ambient conditions or by a flash drying method. The drying again may be performed using a dryer, such as a machine that acts to cause drying of the product or simply a shelf or other support on which the product 22 rests while drying. Following the drying, the coated product 22 is considered another dried product.

A closure or mouth forming process is then performed on the product 22 by a closure-part applicator to produce a closable or closed product. For example, as shown in FIG. 1, a neck fitment 33 is affixed to the dried product. This results in the product being closable subsequently by positioning of a cap, lid or other closure relative to the neck fitment. An exterior coating and/or decoration is then applied to the product 22 by an exterior coating device and/or a decorator, respectively, as shown in the further stage 34, to produce an externally coated and/or decorated product. In one example, the product 22 is dipped into a liquid to coat its outer surface, as shown in FIG. 1. In another example, the outer surface receives the external coating in a different manner. The coating and/or decoration may cover all or only part of an external surface of the product. The product 22 is then allowed to dry in warm air to produce another dried product. In other examples, the drying may be performed using a dryer such as one of those discussed above.

The product 22 may therefore be fully formed, considered the end “receptacle”, and ready to accept contents therein. In other examples, the receptacle may be fully formed without the neck fitment 35 being affixed and/or without the interior coating being applied and/or without the exterior coating being applied and/or without the decoration being applied and/or immediately after one of the drying processes or one of the inspecting and/or evaluating processes. For example, in some cases, the product is provided with the closure part by moulding the closure part during moulding of the product at the first moulding station and/or the second moulding station.

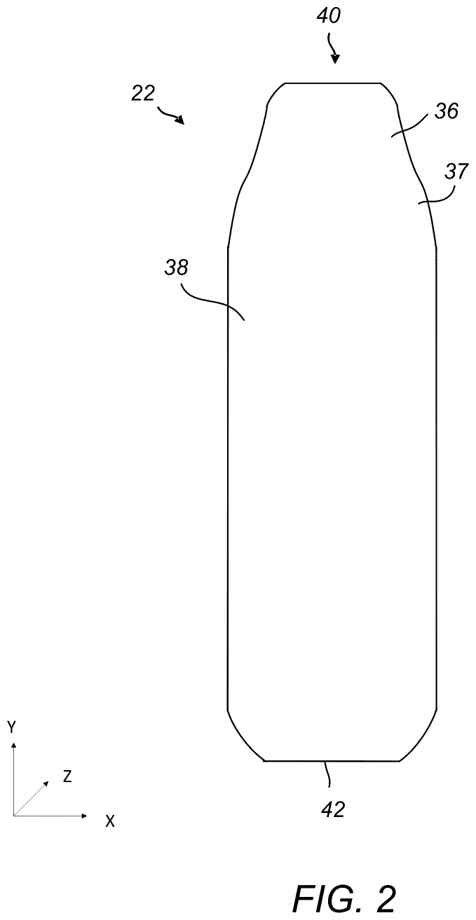

FIG. 2 illustrates an example necked hollow moulded fibre product 22 as it appears after having been moulded in the aluminium mould 25 of the second moulding station and then subjected to the drying stage 30. As discussed above, the product 22 has an internal narrowing, or “neck” 36, between a hollow main body portion 38, in which most of or all the contents of the end receptacle would be stored in use, and an opening 40 through which the contents will enter or leave the end receptacle. The main body portion 38 forms the majority of the product 22 and is cylindrical in shape, although other hollow shapes are envisaged (cuboidal for example). An outer perimeter of the main body portion 38 is substantially consistent across a height (direction Y in FIG. 2) of the main body portion 38. The main body portion 38 extends from a shoulder 37, between the neck 36 and the main body portion 38, to a base 42. The base 42 is partially planar, so as to allow the product 22 to stand thereon without requiring additional support.

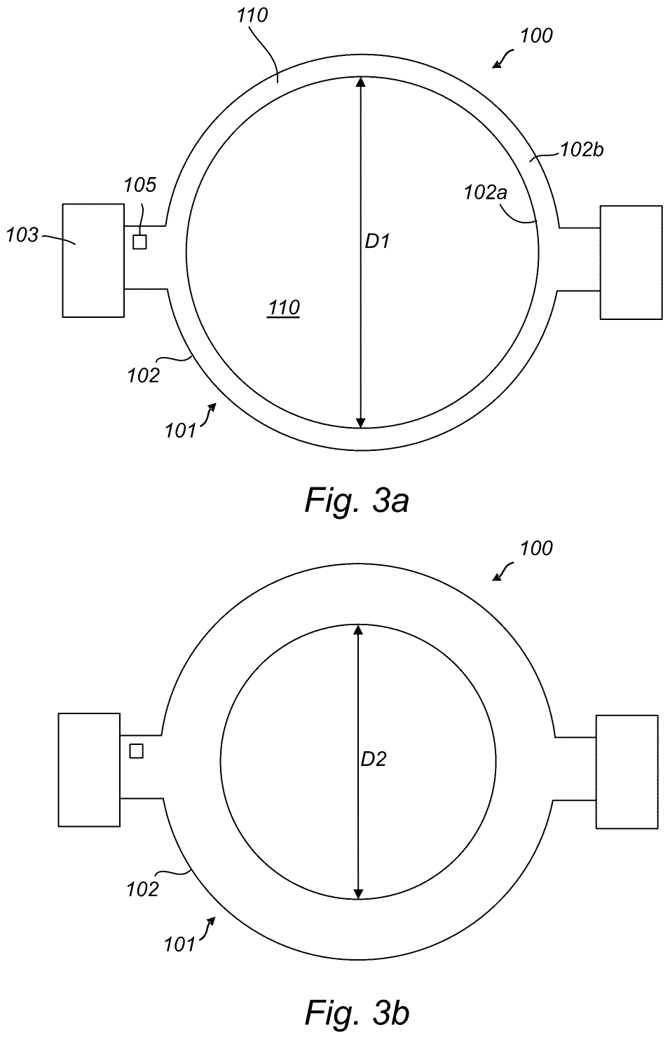

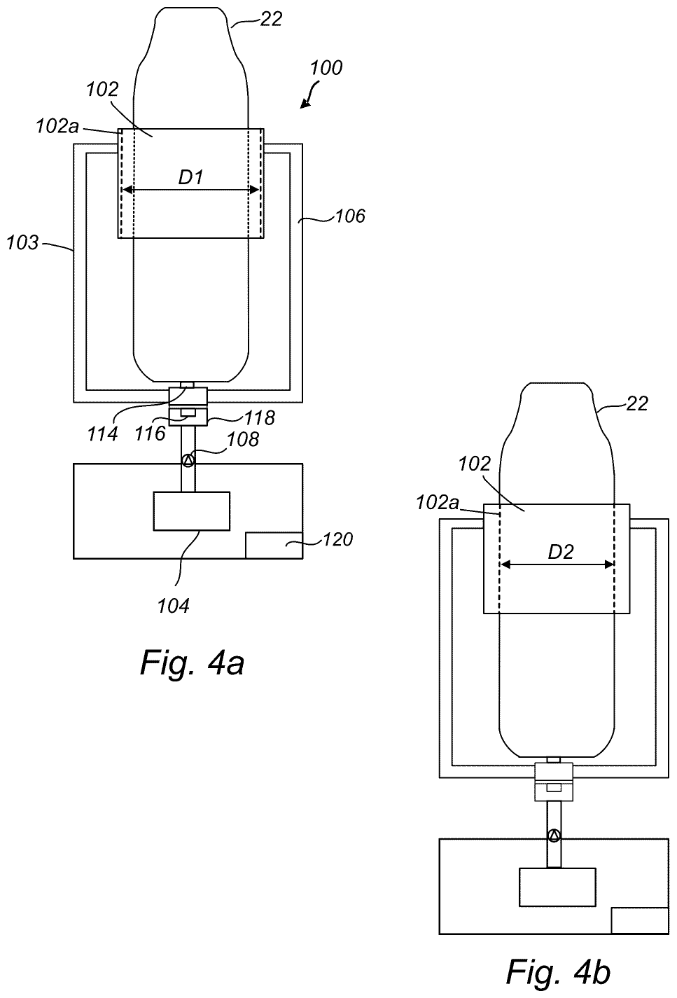

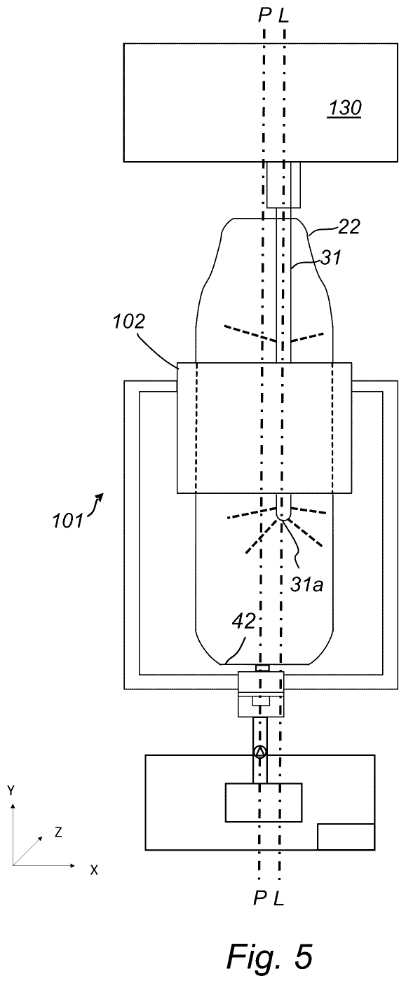

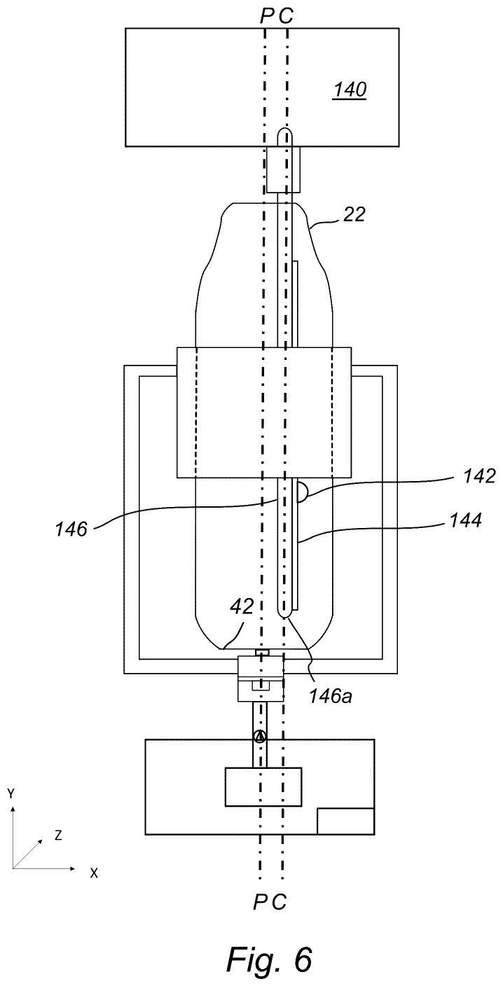

Looking now to FIGS. 3a to 5, a hollow-moulded-fibre-product-positioning device 100 (hereinafter simply referred to as a “positioning device 100”, for brevity) is illustrated, with FIGS. 4b and 5 illustrating the product 22 being held by the positioning device 100. The positioning device 100 comprises two processors, in the form of an interior coating station 130 (see FIG. 5), which comprises the spray lance 31, and an interior inspection station 140 (see FIG. 6), at which the inspection labelled Ins. 2 in FIG. 1 is performed. The positioning device 100 controls a position of the product 22 and controls the interior coating station 130 and the interior inspection station 140, as is discussed in more detail below.

The positioning device 100 comprises a retainer 101, which comprises an inflatable elastomeric annular collar 102 and a frame 103 that supports the collar 102, for retaining the product 22 in use. The frame 103 is sufficiently rigid to support the collar 102 and a product 22 held by the collar 102 in use. As shown in FIG. 4a, the product 22 is inserted into and partly through a space 110 defined and encircled by the collar 102 of the retainer 101 while the retainer 101 is stationary, so that the collar 102 surrounds all of an outside perimeter of the product 22. In this example, the product 22 is inserted into the space 110 by a product insertion mechanism (not shown, but communicatively connected to, and controlled by, the controller 120) that carries the product 22 from the dryer that performed the drying stage 30 and then lowers the product 22 into the space 110. A position sensor 114 is mounted on a base portion of the frame 103, is communicatively connected to the controller 120, senses a position of the product 22 relative to the space 110 and the retainer 101, and outputs to the controller 120 a signal indicative of the position of the product 22. When the controller 120 determines, on the basis of the signal, that the product 22 is suitably located in the positioning device 100, the controller 120 causes the product insertion mechanism to cease movement of the product 22 relative to the retainer 120. At this point, the collar 102 is positioned around part of the main body portion 28 of the product and extends along or across only about 30% of a length of the product 22. In other examples, the product 22 could be inserted into the space 110 in other ways, such as by hand.

In this example, the positioning device 100 has only one retainer 101, which is the only mechanism or device for supporting the product 22 while the spray lance 31 sprays the coating material onto the product 22. In other examples, the positioning device 100 could have plural retainers 101, such as the illustrated retainer 101 and a further retainer in the form of a further collar 102 supported by the frame 103. All of the plural retainers 101 may have the same form and dimensions, or one or more of the plural retainers 101 may differ in form or size from one or more other of the plural retainers 101. For example, in some cases, the positioning device 100 may comprise a further retainer 101 that comprises a second inflatable annular collar that is positionable and sized to locate around the neck 36 and/or shoulder 37 of the product, once the product 22 is fully located in the space 110. The two inflatable annular collars may each extend along or across only a section of the length of the product 22 and may be spaced apart in order to hold the product 22 more steadily.

After the controller 120 causes the product insertion mechanism to cease movement of the product 22 into the space 110, the controller 120 causes the collar 102 of the retainer 101 to expand in order to conform to the product 22. For this purpose, the positioning device 100 has a fluid source (comprising a reservoir 104, storing air, and a pump 108) and tubing 106. The reservoir 104 is fluidically coupled to an interior cavity 102b of the collar 102 by the tubing 106, and the pump 108 is located part way along the tubing 106. The tubing 106 extends through the frame 103 of the retainer 101. The controller 120 is communicatively connected to the pump 108 and causes the pump 108 to operate to pump air from the reservoir 104 to the interior cavity 102b via the tubing 106. This causes the cavity 102b to expand or inflate, so that the collar 102 adopts a donut, or torus, shape. A pressure sensor 105 is communicatively connected to the controller 120, senses an air pressure in the cavity 102b, and outputs to the controller 120 data indicative of the air pressure. The controller 120 controls the inflation on the basis of the data from the pressure sensor 105, so that the controller 120 stops operation of the pump 108 when the controller 120 determines that the air pressure meets or exceeds a predetermined pressure. The predetermined pressure is one at which it is known, such as by prior design or prior trial-and-error, that an inner wall of the collar 102 would be in contact with and urged against the outside surface of the product 22, but the collar 102 would not apply a force to the product 22 that is so great as to unacceptably damage the product 22. In other examples, the fluid source may instead comprise a pressurised air main, in some cases with a regulator configured to take relatively high-pressure air from the air main and turn it into a relatively low-pressure air supply that is suitable for inflating the collar 102.

The collar 102 therefore changes from a first, uninflated configuration (as shown in FIGS. 3a and 4a) with a first internal diameter D1 to a second, inflated configuration (as shown in FIGS. 3b and 4b) with a second internal diameter D2 that is smaller than the first internal diameter D1, during which change an interior (or radially-inwardly-facing) wall 102a the collar 102 comes into contact with the product 22 and is urged against the product 22. In the inflated configuration, the collar 102 conforms to the outside perimeter of the product 22 so that the product 22 adopts a “snug fit” within the collar 102. More specifically, all, or at least a majority, of an inner circumference of the collar 102 contacts the outside surface of the product 22. This, along with the suitably selected material of the collar 102, results in the collar 102 sufficiently gripping or engaging the product 22 to enable the collar 102 to control a position of the product 22 relative to the spray lance 31 during subsequent relative movement of the collar 102 and the spray lance 31.

The spray lance 31 of the interior coating station 130 is then inserted into the product 22, as shown in FIG. 5, to a position where a distal end 31a of the spray lance 31 is spaced apart from the base 42 of the product 22 and a longitudinal axis L-L of the spray lance 31 is parallel to (i.e., not coincident with) a longitudinal axis P-P of the product 22.

The collar 102, and therefore the product 22, is then caused to rotate about the longitudinal axis P-P of the product 22 and relative to spray lance 31 and the rest of the interior coating station 130 multiple times at a rate of 2,000 rpm. In other examples, the speed may be anywhere between 1,500 rpm and 3,000 rpm, for example. This rotation is effected by a motor 116 that is coupled to a pneumatic union 118, which is part way along the tubing 106 and fluidically located between the reservoir 104 and the collar 102. Two parts of the pneumatic union 118 are relatively rotatable about the longitudinal axis P-P of the product 22. When the collar 102 and product 22 are to be rotated, the controller 120 causes an electrical current to be supplied to the motor 116. This causes rotation of the motor 116, which in turn causes rotation of the collar 102, the product 22 and one of the parts of the pneumatic union 118 about the longitudinal axis P-P of the product 22 and relative to the spray lance 31 and the other of the parts of the pneumatic union 118. Accordingly, in driving the rotation of the product 22, the collar 102 manoeuvres the product 22 and controls the position of the product 22 relative to the interior coating station 130.

In an alternative example, the retainer 101 holds the product 22 stationary (e.g., relative to the reservoir 104 and/or the controller 120) and the controller 120 instead causes the spray lance 31 to rotate relative to the retainer 101 and the product 22. In a still further example, a coupling arrangement between the reservoir 104 and the collar 102 other than a pneumatic union 118 may be employed. For example, the coupling arrangement may comprise a connector comprising a pair of parts that interface with each other to fluidly connect the reservoir 104 and the collar 102, and that are detachable from each other to fluidly disconnect the reservoir 104 from the collar 102 and permit relative movement of the reservoir 104 and the collar 102. In order to ensure the collar 102 remains inflated and the reservoir 104 does not vent its contents to atmosphere (or possibly become contaminated with dust), a first valve may be provided between one of the pair of parts and the reservoir 104 and a second valve may be provided between the other of the pair of parts and the collar 102.

However the relative rotational movement of the product 22 and the spray lance 31 is achieved, during the relative rotational movement in this way, the controller 120 causes the spray lance 31 to spray coating material onto an interior surface of the product 22, as shown with diagonal dashed lines in FIG. 5, to produce the internally coated product discussed above. It has been found that offsetting the longitudinal axis L-L of the spray lance 31 from the axis of rotation of the product 22 in this way results in a more even coating of the coating material on the interior surface of the product 22 than if the longitudinal axis L-L were coincident with the axis of rotation.

When enough of the coating material has been applied to the interior surface of the product 22, the controller 120 causes the spray lance 31 to cease spraying the coating material. This may be after a predetermined time period has elapsed since the spray lance 31 began spraying, or after a predetermined quantity of the coating material has been delivered through the spray lance 31, for example. Subsequently, the controller 120 causes the rotation of the retainer 101 and the product 22 relative to the spray lance 31 to cease, through causing a reduction and then a cessation of the supply of the electrical current to the motor 116, and causes withdrawal of the spray lance 31 from the product 22. The product 22 is rotated for a short time after the spray lance 31 ceases spraying, in order to ensure that the product is moving for the full duration that the spray lance 31 is spraying. This better ensures a uniform deposition of the coating material on the interior surface of the product 22 than if the rotation of the product 22 were instead to slow or stop before the spray lance 31 ceases spraying. In other examples, the controller 120 causes the withdrawal of the spray lance 31 before the rotation of the product 22 slows or stops, albeit after causing the spraying to cease.

Thereafter, the retainer 101 manoeuvres the product 22 relative to the interior coating station 130 and relative to the interior inspection station 140 shown in FIG. 6. More specifically, the controller 120 causes the retainer 101 to lift and carry the product 22 away from the interior coating station 130 to the interior inspection station 140. During this manoeuvring, the collar 102 remains inflated in order to securely hold the product 22. Depending on the nature of the coating material applied to the product, the controller 120 may cause the retainer 101 to hold the product 22 stationary for a period of time, or to rotate the product 22 for a period of time, at a location between the interior coating station 130 and the interior inspection station 140, to allow the coating material to at least partially set or cure before being processed or inspected by the interior inspection station 140.

The interior inspection station 140 comprises a light source 142 and a camera array 144 for capturing an image of the interior surface of the product 22 (both shown only schematically in FIG. 6). At this point, the interior surface of the product 22 comprises the coating material that was sprayed by the spray lance 31. The light source 142 and the camera array 144 are communicatively connected to the controller 120, and are mounted on a rod 146 that is insertable into the product 22. When the retainer 101 and the product 22 have arrived at the interior inspection station 140 and are suitably positioned, the rod 146 is then inserted into the product 22, as shown in FIG. 6, to a position where a distal end 146a of the rod 146 is spaced apart from the base 42 of the product 22 and a longitudinal axis C-C of the camera array 144 is parallel to (i.e., not coincident with) the longitudinal axis P-P of the product 22.

The collar 102, and therefore the product 22, is then caused to rotate 360 degrees about the longitudinal axis P-P of the product 22 and relative to rod 146, the camera array 144, the light source 142, and the rest of the interior inspection station 140. This rotation is effected by operation of the motor 116 discussed above. During the relative rotational movement in this way, the controller 120 causes the light source 142 to emit light and the camera array 144 to capture an image of the interior surface of the product 22 as the camera array 144 scans the interior surface, to produce the evaluated product discussed above. Offsetting the longitudinal axis C-C of the camera array 144 from the axis of rotation of the product 22 in this way results in the light source 142 and the camera array 144 being positioned relatively close to the interior surface of the product 22, which can improve a quality of the image captured by the camera array 144 as compared with a scenario in which the camera array 144 is instead positioned further away from the interior surface.

Since the relative rotation between the product 22 and the camera array 144 is about the longitudinal axis P-P of the product 22, a distance between the interior surface of the product 22 and the camera array 144 (or, more specifically, photoreceptor(s) of the camera array 144) is constant or substantially constant during the rotation. Accordingly, a degree of brightness of different portions of the captured image is relatively constant, which can aid subsequent assessment of the full image. In an alternative example, the relative rotation is about the longitudinal axis C-C of the camera array 144, such as by the retainer 101 holding the product 22 stationary (e.g., relative to the controller 120) and the controller 120 instead causing the rod 146 to rotate relative to the retainer 101 and the product 22. In such an alternative example, processing of the captured image data may be required to compensate for the variation in brightness, in order to render the image suitable for analysis.

However the relative rotational movement of the product 22 and the camera array 144 is achieved, the resultant image captured by the camera array 144 is then analysed to determine one or more properties of the interior surface, such as a distribution of the coating material.

When the interior inspection station 140 has captured the image of the interior surface of the product 22, the controller 120 causes the rotation of the retainer 101 and the product 22 relative to the rod 146 to cease, through causing a reduction and then a cessation of the supply of the electrical current to the motor 116, and causes withdrawal of the rod 146 from the product 22. In other examples, the controller 120 causes the withdrawal of the rod 146 before the rotation of the product 22 slows or stops.

Then, the controller 120 causes deflation of the collar 102. This is achieved in this example by way of the controller 120 causing the pump 108 to operate in reverse, to thereby quickly draw the air from the interior cavity 102b of the collar 102 via the tubing 106. The collar 102 therefore changes from the inflated configuration (as shown in FIGS. 3b and 4b) to the uninflated configuration (as shown in FIGS. 3a and 4a), which results in the radially-inwardly-facing wall 102a the collar 102 coming out of contact with the product 22. In this example, the product 22 is then lifted from the space 110 by a product extraction mechanism (not shown, but communicatively connected to, and controlled by, the controller 120) that carries the product 22 to a drying station where the drying process 32 is performed.

In another example, the deflation may instead be achieved by the controller 120 causing one or more valves (such as the second valve and optionally also the first valve, or instead a valve distinct from the first and second valves) to open to the atmosphere, to allow the collar 102 to deflate until the interior cavity 102b reaches atmospheric pressure. Such an arrangement would be sufficient if, for example, it was unnecessary to completely empty the interior cavity 102b of the collar 102.

It will be appreciated that, while the collar 102 is inflated and in contact with the product 22, the retainer 101 is the sole device or mechanism supporting the product 22 in this example.

While, in this example, the processors are an interior coating station and an interior inspection station, in other examples other forms of processor may be present. Example such processors are stations for applying coatings, decoration or markings on exteriors of products, stations for filling products, and stations for applying closures to products. Indeed, in other examples, one or more positioning devices may be used anywhere in the receptacle manufacturing line shown in FIG. 1. Moreover, while in this example the two processors of the positioning device 100 are non-human, in other examples a human may perform processing of the product 22, such as a visual inspection of the product, and therefore be considered a “processor” as such.

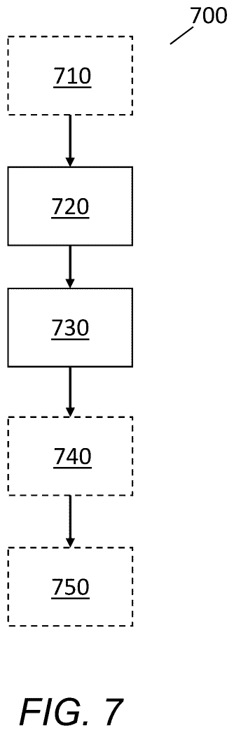

FIG. 7 shows a block diagram of an example method 700 of controlling a position of a hollow moulded fibre product, such as the product 22 discussed above, to enable at least one processor, such as the processors 130, 140 discussed above, to perform a process on the hollow moulded fibre product. The method 700 comprises: inserting 710 the product at least partly through a space, such as the space 110 above, defined by a retainer, such as the retainer 101 above; conforming 720 the retainer to at least a majority of an outside perimeter of the product; using 730 the retainer to control the position of the product relative to the at least one processor; the at least one processor processing 740 at least part of an interior surface of the product; and manoeuvring 750 the product using the retainer after the at least one processor completes the processing 740.

It will be appreciated that there is also provided a control system that is configured to cause a positioning device to conform a retainer to at least a majority of an outside perimeter of a hollow moulded fibre product, and then to cause the positioning device to use the retainer to control the position of the hollow moulded fibre product relative to at least one processor for performing a process on the hollow moulded fibre product.

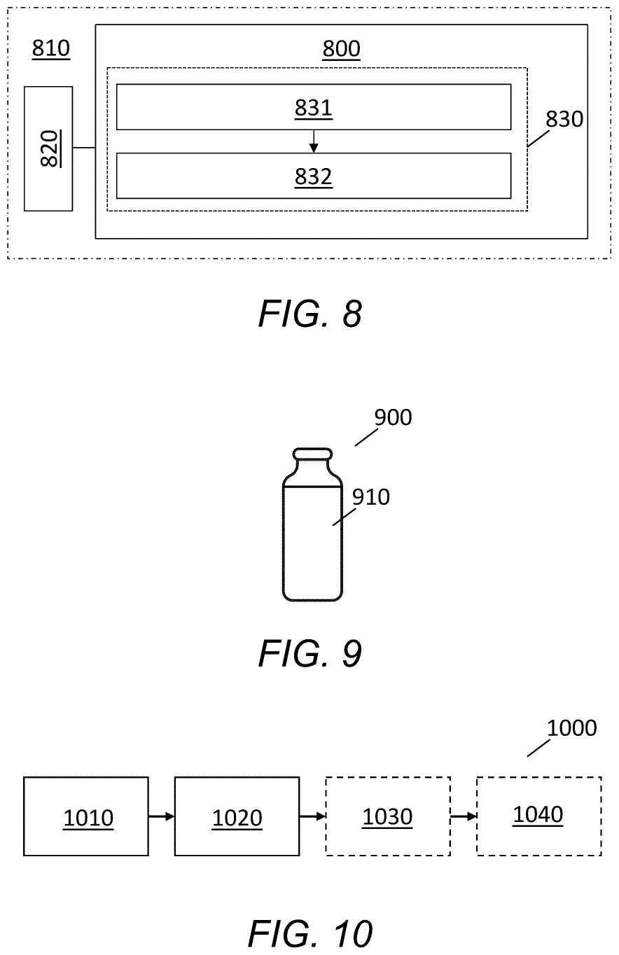

FIG. 8 shows a schematic diagram of a non-transitory computer-readable storage medium 800 according to an example. The non-transitory computer-readable storage medium 800 stores instructions 830 that, if executed by a computer processor 820 of a control system 810 of a hollow-moulded-fibre-product-positioning device, cause the computer processor 820 to cause the hollow-moulded-fibre-product-positioning device to perform a method according to an example. In one example, the control system 810 is or comprises the controller 120 as described above. The instructions 830 comprise: causing a retainer to conform to at least a majority of an outside perimeter of a hollow moulded fibre product, and then causing the retainer to be used to control the position of the hollow moulded fibre product relative to at least one processor for performing a process on the hollow moulded fibre product. In other examples, the instructions 330 comprise instructions to perform any other example methods described herein.

It will also be appreciated that there also is provided a receptacle manufacturing line (such as that shown in FIG. 1) comprising a positioning device for controlling a position of a hollow moulded fibre product to enable at least one processor to perform a process on the hollow moulded fibre product to provide a processed hollow moulded fibre product, and apparatus for performing at least one additional process on the processed hollow moulded fibre product to provide the receptacle. Similarly, also provided is a method of manufacturing a receptacle, the method comprising: conforming a retainer to at least a majority of an outside perimeter of a hollow moulded fibre product, and then using the retainer to control the position of the hollow moulded fibre product relative to at least one processor to enable the at least one processor to perform a process on the hollow moulded fibre product to provide a processed hollow moulded fibre product, and then performing at least one additional process on the processed hollow moulded fibre product to provide the receptacle. Examples of the “at least one additional process” are described above with reference to FIG. 1.

Also provided, as a result of the content of the present application, is use of a receptacle obtained by any of the methods described herein to contain contents. An example such receptacle 900, in the form of a necked receptacle and specifically a bottle, containing contents 910 is shown in FIG. 9. The use could be, for example, by a person who puts the contents into the receptacle, by a person who transports the contents, or by a person who wishes to dispose of (for example, to a consumer or end user), offer to dispose of (for example, to a consumer or end user), import, or keep the contents whether for disposal or otherwise. The contents could, for example, be any one or more of the example contents described herein.

Also provided is a method of providing a content-containing receptacle. An example such method 1000 is shown in FIG. 10. The method 1000 comprises providing 1010 the receptacle, in the form of a necked receptacle and specifically a bottle, and then providing 1020 the contents in the receptacle. In this example, block 1020 follows block 1010, so that block 1020 comprises putting the contents into the receptacle that has been provided at block 1010. However, in some other examples, blocks 1010 and 1020 are performed concurrently, so that the providing 1010 the receptacle comprises providing the receptacle with the contents already present in the receptacle. The contents could, for example, be any one or more of the example contents described herein. The method 1000 also comprises closing 1030 an opening of the receptacle after block 1020, and applying 1040 a label or indicia to the receptacle after block 1030. In this example, block 1030 involves applying a heat seal to the opening and then screwing a cap or lid onto the receptacle, and block 1040 comprises adhering a label onto the receptacle.

In respective other examples, the order of blocks 1030 and 1040 is reversed, blocks 1030 and 1040 are performed concurrently, block 1030 is omitted, and block 1040 is omitted. In some examples, block 1040 occurs before block 1020, or block 1040 occurs during block 1020. For example, in some cases, the label or indicia is applied to the receptacle, then the contents are provided in the receptacle, and then the receptacle is closed.

It will be appreciated that the method 1000 could be performed by the same party that manufactures the receptacle, for example so that block 1010 comprises the method discussed above with reference to the manufacturing line shown in FIG. 1. Alternatively, the method 1000 could be performed by a different party to that which manufactures the receptacle. In such an alternative, the different party performs block 1010 by way of obtaining the receptacle from the party that manufactures the receptacle (such as by way of the method discussed above with reference to FIG. 1) or from an intermediary.

Example embodiments of the present invention have been discussed, with reference to the examples illustrated. However, it will be appreciated that variations and modifications may be made without departing from the scope of the invention as defined by the appended claims.

What is claimed is:

1. A method of controlling a position of a hollow moulded fibre product to enable at least one processor to perform a process on the hollow moulded fibre product, the method comprising:
conforming a retainer to at least a majority of an outside perimeter of the hollow moulded fibre product; and
then using the retainer to control the position of the hollow moulded fibre product relative to the at least one processor.

2. The method of claim 1, wherein the using the retainer to control the position of the hollow moulded fibre product comprises manoeuvring the retainer relative to the at least one processor, such that the hollow moulded fibre product is moved from a first position to a second position.

3. The method of claim 1, comprising inserting the hollow moulded fibre product at least partly through a space defined by the retainer.

4. The method of claim 1, comprising lifting the hollow moulded fibre product using the retainer, such that the retainer supports the hollow moulded fibre product.

5. The method of claim 1, wherein the conforming the retainer comprises inflating the retainer with a fluid.

6. The method of claim 5, comprising controlling the expansion of the retainer using a pressure sensor and a controller, wherein the pressure sensor is configured to sense a pressure in the retainer and output data representing the pressure to the controller, and the controller is configured to control the expansion of the retainer based on the data.

7. The method of claim 1, wherein the method comprises the at least one processor processing at least part of an interior surface of the hollow moulded fibre product.

8. The method of claim 7, wherein the method comprises rotating the hollow moulded fibre product, using the retainer, while the at least one processor processes the at least part of the interior surface of the hollow moulded fibre product.

9. The method of claim 7, wherein the method comprises manoeuvring the hollow moulded fibre product using the retainer after the at least one processor completes the processing of the at least part of the interior surface of the hollow moulded fibre product.

10. A hollow-moulded-fibre-product-positioning device for controlling a position of a hollow moulded fibre product to enable at least one processor to perform a process on the hollow moulded fibre product, the hollow moulded fibre product positioning device comprising a retainer configured to be conformable to at least a majority of an outside perimeter of the hollow moulded fibre product to enable the retainer to then control the position of the hollow moulded fibre product relative to the at least one processor.

11. The device of claim 10, wherein the retainer comprises a collar configured to at least partially enclose the hollow moulded fibre product.

12. The device of claim 10, wherein the device comprises the at least one processor.

13. The device of claim 12, wherein the at least one processor comprises at least one interior processing device configured to process at least part of an interior of the hollow moulded fibre product while the position of the hollow moulded fibre product relative to the at least one processor is controlled by the device.

14. The device of claim 13, wherein the at least one interior processing device comprises one or both of:
an interior coating device configured to coat at least part of the interior of the hollow moulded fibre product, and
an interior inspection device configured to inspect at least part of the interior of the hollow moulded fibre product.

15. The device of claim 10, wherein the hollow-moulded-fibre-product-positioning device comprises a fluid source coupled to the retainer, the fluid source configured to inflate the retainer to cause the retainer to conform to at least a majority of an outside perimeter of the hollow moulded fibre product, in use.

16. The device of claim 15, wherein the hollow-moulded-fibre-product-positioning device comprises a coupling arrangement between the fluid source and the retainer, the coupling arrangement comprising:
a rotary pneumatic union; or
a pair of co-operable interfaces between a first valve and a second valve, the first valve and the second valve configured to close fluid flow paths from the fluid source to one of the interfaces and from the other of the interfaces to the retainer, respectively, and the pair of co-operable interfaces configured to be disconnectable from each other, to permit movement of the one of the interfaces and the fluid source relative to the other of the interfaces and the retainer, and connectable to each other to fluidically connect the first valve to the second valve.

17. The device of claim 10, wherein the hollow-moulded-fibre-product-positioning device comprises a plurality of retainers, each of the retainers configured to conform to the majority of an outside perimeter of a respective hollow moulded fibre product.

18. A receptacle manufacturing line comprising the device of claim 10 for controlling the position of the hollow moulded fibre product to enable the at least one processor to perform the process on the hollow moulded fibre product to provide a processed hollow moulded fibre product, and apparatus for performing at least one additional process on the processed hollow moulded fibre product to provide the receptacle.

19. A control system configured to cause a hollow-moulded-fibre-product-positioning device to perform the method of claim 1.

20. A non-transitory storage medium storing machine-readable instructions that, when executed by a computer processor of a control system of a hollow-moulded-fibre-product-positioning device, cause the computer processor to cause the hollow-moulded-fibre-product-positioning device to perform the method of claim 1.
